(19) United States
(12) Patent Application Publication
(10) Pub. No.: US 2012/0273247 A1
(43) Pub. Date: Nov. 1, 2012

(54) COAXIAL CABLE

(75) Inventor: Hideyuki MATSUURA, Kawasaki (JP)

(73) Assignee: FUJITSU LIMITED, Kawasaki-shi (JP)

(21) Appl. No.: 13/365,781

(22) Filed: Feb. 3, 2012

(30) Foreign Application Priority Data
Apr. 26, 2011 (JP) 2011-098609

(51) Int. Cl. H01B 7/18

(52) U.S. Cl. 174/102 R

(57) ABSTRACT

A coaxial cable includes an inner conductive wire, an insulating layer, an outer conductor layer, and a shielding conductor. The insulating layer covers the outer circumference of the inner conductive wire. The outer conductor layer covers the outer circumference of the insulating layer and includes an opening that exposes a part of the insulating layer. The shielding conductor is slidably attached to the outer circumference of the outer conductor layer and is configured to shield at least a part of the opening while sliding on the circumference of the outer conductor layer so as to increase or decrease the area of the insulating layer exposed from the opening.

### CROSS-REFERENCE TO RELATED APPLICATION

This application is based upon and claims the benefit of priority of the prior Japanese Patent Application No. 2011-098609, filed on Apr. 26, 2011, the entire contents of which are incorporated herein by reference.

### FIELD

The embodiments discussed herein are directed to a coaxial cable.

### BACKGROUND

In a wireless communication system or a wireless power transmission system, coaxial cables are used as transmission lines that connect devices, and it is preferable to adjust the phase of signals transmitted through the coaxial cables. For example, a phase adjuster is disposed between the lines of coaxial cables, and the electric field of the transmission line is changed by the phase adjuster, so that the phase is adjusted.

However, in a method of adjusting the phase with the phase adjuster, two coaxial cables are connected to a phase modulator so that the phase modulator is installed in a midway of a line, which incurs a large load on the connecting operation.

Therefore, in the related art, a technique of adjusting the phase by processing a coaxial cable itself without using a phase adjuster has been proposed. In the technique of the related art, a part of an outer conductor layer of a coaxial cable is peeled off to form an opening configured to expose an inner insulating layer, so that inductive or capacitive reactance is changed and a phase lead or a phase lag occurs when the coaxial cable is substituted with an equivalent circuit is changed. In this way, the phase can be adjusted (see Japanese Laid-open Patent Publication No. 2004-056687 and Japanese Laid-open Patent Publication No. 2009-224044).

However, in the technique of the related art in which the phase is adjusted by processing the coaxial cable itself, there is a problem in that the work load at a workplace is large, and fine adjustment of phase is difficult.

That is, in the related art, when the area of an opening formed by peeling a part of an outer conductor layer of a coaxial cable is different from a target area, a worker at the workplace needs to readjust the dimensions of the opening by peeling the outer conductor layer again, which increases the work load at the workplace. Moreover, in a case in which the worker at the workplace readjusts the dimensions of the opening, the area of the opening may increase excessively depending on the skill of the worker. As a result, it may be difficult to finely adjust the phase.

### SUMMARY

According to an aspect of an embodiment of the invention, a coaxial cable includes an inner conductive wire; an insulating layer configured to cover an outer circumference of the inner conductive wire; an outer conductor layer configured to cover an outer circumference of the insulating layer and include an opening that exposes a part of the insulating layer; and a shielding conductor configured to be slidably attached to the outer circumference of the outer conductor layer so as to shield at least a part of the opening while sliding on the outer circumference of the outer conductor layer, thereby increasing or decreasing an area of the insulating layer exposed from the opening.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a perspective view illustrating the appearance of a coaxial cable according to a first embodiment;

FIG. 2 is a diagram illustrating an aspect in which a general coaxial cable is segmented into a plurality of segments;

FIG. 3 is a diagram illustrating an equivalent circuit of the coaxial cable illustrated in FIG. 2;

FIG. 4 is a diagram illustrating an aspect in which an opening is formed in an outer conductor layer of the coaxial cable illustrated in FIG. 2;

FIG. 5 is a diagram illustrating an equivalent circuit of the coaxial cable illustrated in FIG. 4;

FIG. 6 is a diagram illustrating the positional relation between a C-shaped bracket and an opening before a slide operation is received;

FIG. 7 is a diagram illustrating the positional relation between a C-shaped bracket and an opening when a slide operation is received;

FIG. 8 is a diagram illustrating the relation between the position of a C-shaped bracket and an exposed area of an insulating layer;

FIG. 9 is a perspective view illustrating the appearance of a coaxial cable according to a second embodiment;

FIG. 10 is a diagram illustrating the positional relation between a C-shaped bracket and an opening before a slide operation is received;

FIG. 11 is a diagram illustrating the positional relation between a C-shaped bracket and an opening when a slide operation is received;

FIG. 12 is a diagram illustrating the positional relation between a C-shaped bracket and an opening when a slide operation is received;

FIG. 13 is a diagram illustrating the relation between the position of a C-shaped bracket and an exposed area of an insulating layer;

FIG. 14 is a perspective view illustrating the appearance of a coaxial cable according to a third embodiment;

FIG. 15 is a diagram illustrating the positional relation between a C-shaped bracket and an opening before a slide operation in the θ direction is received;

FIG. 16 is a diagram illustrating the positional relation between a C-shaped bracket and an opening when a slide operation in the θ direction is received;

FIG. 17 is a diagram illustrating the relation between the position of a C-shaped bracket and an exposure distance of an insulating layer;

FIG. 18 is a diagram illustrating the positional relation between a C-shaped bracket and an opening before a slide operation in the X direction is received;

FIG. 19 is a diagram illustrating the positional relation between a C-shaped bracket and an opening when a slide operation in the X direction is received; and

FIG. 20 is a diagram illustrating the relation between the position of a C-shaped bracket and an exposed area of an insulating layer.

### DESCRIPTION OF EMBODIMENTS

Preferred embodiments of the present invention will be explained with reference to accompanying drawings. The invention is not limited to these embodiments.

### [a] First Embodiment

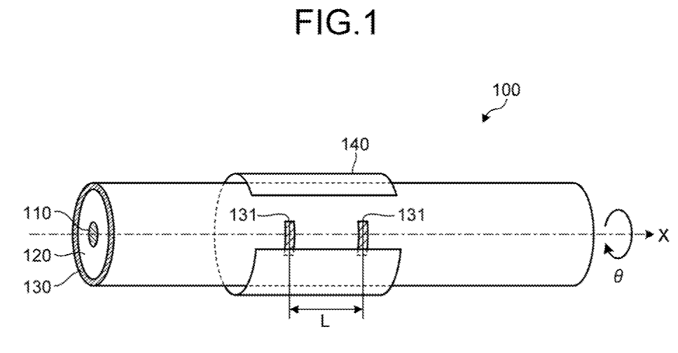

First, the configuration of a coaxial cable 100 according to the first embodiment will be described. FIG. 1 is a perspective view illustrating the appearance of the coaxial cable 100 according to the first embodiment. As illustrated in FIG. 1, the coaxial cable 100 includes an inner conductive wire 110, an insulating layer 120, an outer conductor layer 130, and a C-shaped bracket 140.

The inner conductive wire 110 is formed in an approximately circular shape in cross-sectional view by a conductive material so as to extend in one direction. In the example illustrated in FIG. 1, the inner conductive wire 110 extends in the X direction. The “X direction” indicated by the straight line arrow in FIG. 1 corresponds to an “axial direction” of the inner conductive wire 110. Moreover, in the following description, the term simply referred to as an “X direction” is meant to include the positive and negative directions.

The insulating layer 120 is formed of an insulator and covers the circumference of the inner conductive wire 110.

The outer conductor layer 130 is formed of a conductive material and covers the circumference of the insulating layer 120. The outer conductor layer 130 includes two openings 131 and 131 arranged along the X direction. The openings 131 and 131 are formed by peeling a part of the outer conductor layer 130 so that a part of the insulating layer 120 is exposed.

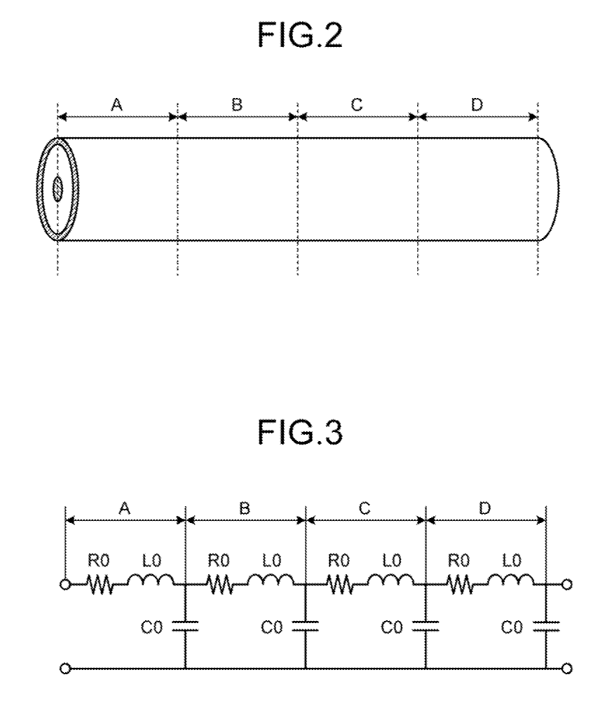

Here, the reason why the openings 131 and 131 are formed in the outer conductor layer 130 of the coaxial cable 100 will be described. First, a general coaxial cable in which no opening is formed in an outer conductor layer will be described. FIG. 2 is a diagram illustrating an aspect in which a general coaxial cable is segmented into a plurality of segments. FIG. 3 is a diagram illustrating an equivalent circuit of the coaxial cable illustrated in FIG. 2. The coaxial cable illustrated in FIG. 2 is segmented into four segments A to D. As illustrated in FIG. 3 in which the coaxial cable segmented into four segments A to D is substituted with an equivalent circuit, a resistor having a resistance value of R0 and a coil having an inductance of L0 are connected in series, and these resistor and coil are connected in parallel to a capacitor having a capacitance of C0. In a general aspect, the resistance value R0, the inductance L0, and the capacitance C0 are the same values for all of the four segments A to D.

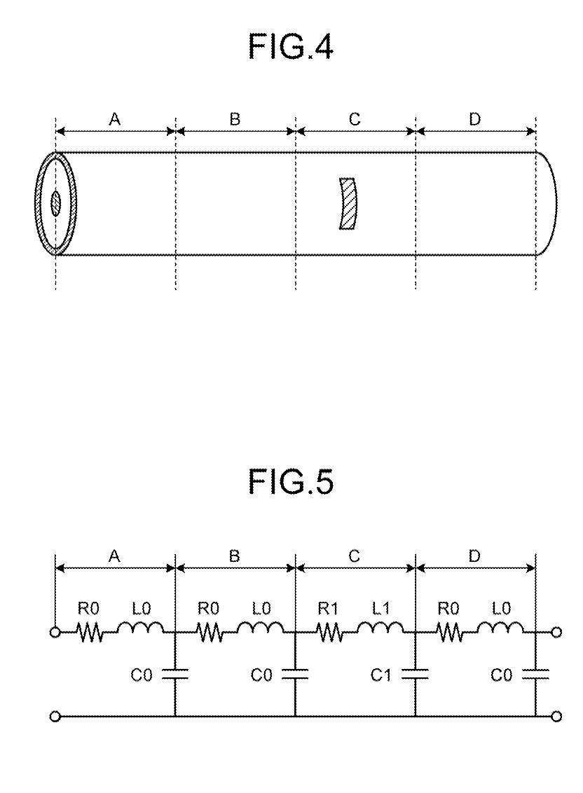

Next, a coaxial cable in which an opening is formed in an outer conductor layer will be described. When an opening is formed by peeling a part of the outer conductor layer of a coaxial cable, a characteristic impedance of a segment in which an opening is formed in the coaxial cable changes. In other words, the resistance value, the inductance, and the capacitance of a segment in which an opening is formed in the coaxial cable change. For example, as illustrated in FIG. 4, when an opening is formed in a segment C of the coaxial cable illustrated in FIG. 2, the resistance value R0, the inductance L0, and the capacitance C0 of the segment C in which the opening is formed change. That is, it can be understood from the equivalent circuit illustrated in FIG. 5 that the resistance value R0, the inductance L0, and the capacitance C0 of the segment C in which the opening is formed are changed to a resistance value R1, an inductance L1, and a capacitance C1, respectively. FIG. 4 is a diagram illustrating an aspect in which an opening is formed in an outer conductor layer of the coaxial cable illustrated in FIG. 2. FIG. 5 is a diagram illustrating an equivalent circuit of the coaxial cable illustrated in FIG. 4.

As above, when an opening is formed in the outer conductor layer, the resistance value, the inductance, and the capacitance of a segment in which an opening is formed in the coaxial cable change so that inductive or capacitive properties become dominance in that segment. As a result, a phase lead or lag occurs in the opening. Moreover, it is known that the amount of the phase lead or lag increases as the area of an insulating layer exposed from the opening increases. Therefore, in the coaxial cable 100 of the present embodiment, the openings 131 and 131 are formed in the outer conductor layer 130 in order to cause a phase lead or lag to occur in the openings 131 and 131.

Returning to FIG. 1, the description will be continued. The distance L between the openings 131 and 131 is set to ¼ of the wavelength of a frequency band being used. By doing so, reflection waves occurring in the openings 131 and 131 may be canceled and impedance mismatch may be suppressed.

The C-shaped bracket 140 is formed in an approximately C-shape in cross-sectional view by a conductive and spring material such as a metal and is slidably attached to the circumference of the outer conductor layer 130. That is, the C-shaped bracket 140 is attached to the circumference of the outer conductor layer 130 by being externally attached to the outer conductor layer 130 using its spring properties and is slidable in the X direction and θ direction in relation to the circumference of the outer conductor layer 130. The “θ direction” indicated by the arc-shaped arrow in FIG. 1 corresponds to the “circumferential direction” of the inner conductive wire 110. Moreover, in the following description, the term simply referred to as a “θ direction” is meant to include the positive and negative directions.

Moreover, the C-shaped bracket 140 is disposed in a portion of the circumference of the outer conductor layer 130 near the openings 131 and 131. When a slide operation is received, the C-shaped bracket 140 shields a part of the openings 131 and 131 while sliding along the θ direction on the circumference of the outer conductor layer 130, whereby the area of the insulating layer 120 exposed from the openings 131 and 131 increases or decreases. The C-shaped bracket 140 is an example of a shielding conductor.

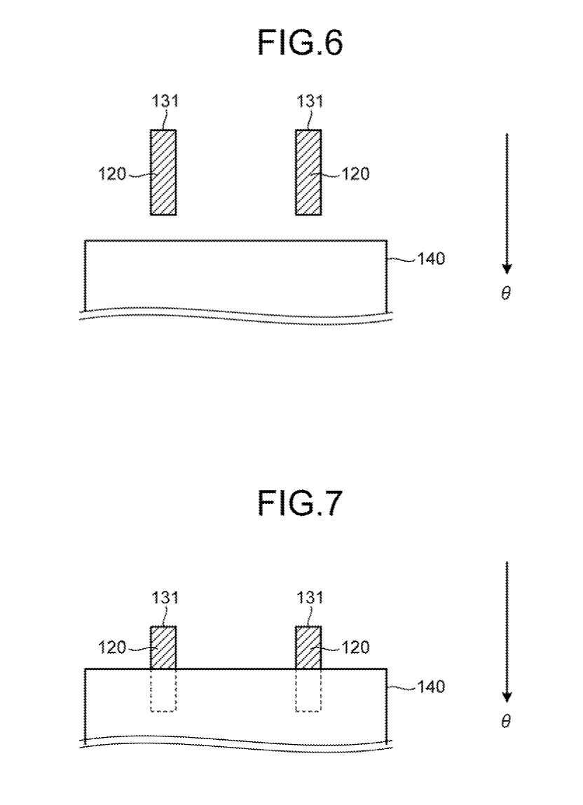

Next, an operation of shielding the opening 131 by the C-shaped bracket 140 will be described. FIG. 6 is a diagram illustrating the positional relation between the C-shaped bracket 140 and the openings 131 and 131 before a slide operation is received. FIG. 7 is a diagram illustrating the positional relation between the C-shaped bracket 140 and the openings 131 and 131 when a slide operation is received.

As illustrated in FIG. 6, before a slide operation is received, the C-shaped bracket 140 does not shield the openings 131 and 131. In this state, the area of the insulating layer 120 exposed from the openings 131 and 131 becomes its maximum.

When a slide operation in the negative θ direction is received, the C-shaped bracket 140 shields the lower parts of the openings 131 and 131 while sliding in the negative θ direction on the circumference of the outer conductor layer 130 as illustrated in FIG. 7. In this way, the C-shaped bracket 140 decreases the area of the insulating layer 120 exposed from the openings 131 and 131. On the other hand, when a slide operation in the positive θ direction is received, the C-shaped bracket 140 which is already shielding the lower parts of the openings 131 and 131 as illustrated in FIG. 7 opens the lower parts of the openings 131 and 131 while sliding in the positive θ direction on the circumference of the outer conductor layer 130. In this way, the C-shaped bracket 140 increases the area of the insulating layer 120 exposed from the openings 131 and 131. In the following description, the area of the insulating layer 120 exposed from the openings 131 and 131 is sometimes referred simply to as an “exposed area.”

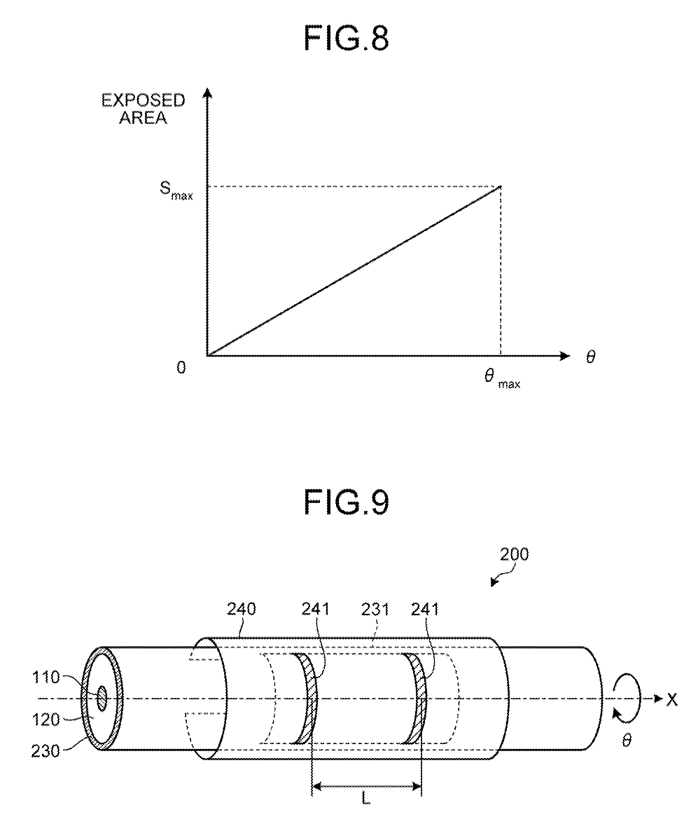

FIG. 8 is a diagram illustrating the relation between the position of the C-shaped bracket 140 and the exposed area of the insulating layer 120. The horizontal axis in FIG. 8 represents the position in the θ direction of the C-shaped bracket 140 on the circumference of the outer conductor layer 130, and the vertical axis in FIG. 8 represents the exposed area of the insulating layer 120. Moreover, it is assumed that when the C-shaped bracket 140 is at the position θₘₐₓ, the C-shaped bracket 140 does not receive a slide operation nor shield the openings 131 and 131.

As illustrated in FIG. 8, when the C-shaped bracket 140 is at the position θₘₐₓ, the exposed area of the insulating layer 120 reaches its maximum value Sₘₐₓ. It can be understood that since the openings 131 and 131 are shielded by the C-shaped bracket 140 as the C-shaped bracket 140 moves on the circumference of the outer conductor layer 130 from the position θₘₐₓ in the negative θ direction, the exposed area of the insulating layer 120 decreases. On the other hand, it can be understood that since the openings 131 and 131 are open as the C-shaped bracket 140 moves on the circumference of the outer conductor layer 130 in the positive θ direction, the exposed area of the insulating layer 120 increases.

As above, by causing the C-shaped bracket 140 to slide in relation to the circumference of the outer conductor layer 130 so as to shield a part of the openings 131 and 131, the exposed area of the insulating layer 120 may be freely increased or decreased. As described above, it can be understood that the amount of the phase lead or lag increases as the exposed area of the insulating layer 120 increases. From this, it can be understood that the phase can be finely adjusted to a target value by freely increasing or decreasing the exposed area of the insulating layer 120.

As described above, according to the first embodiment, the C-shaped bracket 140 is slidably attached to the circumference of the outer conductor layer 130 in which the openings 131 and 131 are formed and shielding a part of the openings 131 and 131 with the slid C-shaped bracket 140, whereby the exposed area of the insulating layer 120 increases or decreases. Therefore, as compared to the related art in which a worker at the workplace peels the outer conductor layer to adjust the dimensions of the opening itself, the exposed area of the insulating layer 120 can be finely adjusted to a target value by only performing a simple operation of a slide operation of the C-shaped bracket 140 without peeling the outer conductor layer. As a result, the work load at the workplace may be alleviated and fine adjustment of phase may be made easily.

Moreover, according to the first embodiment, a part of the openings 131 and 131 is shielded by the C-shaped bracket 140 which is slid in the θ direction in relation to the circumference of the outer conductor layer 130. Therefore, fine adjustment of phase can be executed by a simple slide operation in the circumferential direction of the coaxial cable and a slide operation in the axial direction is not necessary. As a result, the workability may be improved when there is no sufficient work space in the axial direction.

In the first embodiment, although a configuration in which the C-shaped bracket 140 is externally attached to the outer conductor layer 130 by using its spring properties has been described, the C-shaped bracket 140 may be attached to the outer conductor layer 130 through another fixture. That is, in such a configuration, the C-shaped bracket 140 may be slidably attached to the circumference of the outer conductor layer 130 through another fixture while holding conduction with the outer conductor layer 130.

### [b] Second Embodiment

In the first embodiment, an example in which the exposed area of the insulating layer 120 is increased or decreased by shielding a part of the openings 131 and 131 formed in the outer conductor layer 130 with the slid C-shaped bracket 140 has been described. However, a notch hole may be formed in the C-shaped bracket, and a part of an opening of the outer conductor layer may be shielded with the surface surrounding the notch hole of the slid C-shaped bracket, whereby the area of the insulating layer exposed from the opening overlapping the notch hole is increased or decreased. Therefore, in the second embodiment, a configuration in which a notch hole is formed in the C-shaped bracket, and a part of an opening of the outer conductor layer is shielded with the surface surrounding the notch hole of the slid C-shaped bracket, whereby the area of the insulating layer exposed from the opening overlapping the notch hole is increased or decreased will be described.

FIG. 9 is a perspective view illustrating the appearance of a coaxial cable 200 according to the second embodiment. In FIG. 9, the same portions as those of FIG. 1 will be denoted by the same reference numerals, and the description thereof will not be provided. Moreover, the “X direction” indicated by the straight line arrow in FIG. 1 corresponds to the “axial direction” of the inner conductive wire 110. Moreover, in the following description, the term simply referred to as an “X direction” is meant to include the positive and negative directions. Moreover, the “θ direction” indicated by the arc-shaped arrow in FIG. 1 corresponds to the “circumferential direction” of the inner conductive wire 110. Moreover, in the following description, the term simply referred to as a “θ direction” is meant to include the positive and negative directions.

As illustrated in FIG. 9, the coaxial cable 200 includes the inner conductive wire 110, the insulating layer 120, an outer conductor layer 230, and a C-shaped bracket 240.

The outer conductor layer 230 is formed of a conductive material and covers the circumference of the insulating layer 120. The outer conductor layer 230 includes one opening 231. The opening 231 is formed by peeling a part of the outer conductor layer 230 so that a part of the insulating layer 120 is exposed.

The C-shaped bracket 240 is formed in an approximately C-shape in cross-sectional view by a conductive and spring material such as a metal and is slidably attached to the circumference of the outer conductor layer 230. That is, the C-shaped bracket 240 is attached to the circumference of the outer conductor layer 230 by being externally attached to the outer conductor layer 230 using its spring properties and is slidable in the X direction and θ direction in relation to the circumference of the outer conductor layer 230.

Moreover, the C-shaped bracket 240 is disposed on the circumference of the outer conductor layer 230 so as to cover approximately the entire region of the opening 231 of the outer conductor layer 230. The C-shaped bracket 240 includes two notch holes 241 and 241 which are arranged along the X direction so as to overlap the opening 231 of the outer conductor layer 230. The distance L between the notch holes 241 and 241 is set to ¼ of the wavelength of a frequency band being used. By doing so, reflection waves occurring in the notch holes 241 and 241 may be canceled and impedance mismatch may be suppressed.

When a slide operation is received, the C-shaped bracket 240 slides along the θ direction on the circumference of the outer conductor layer 230. Moreover, the C-shaped bracket 240 shields a part of the opening 231 with the surface surrounding the notch holes 241 and 241 while sliding along the θ direction on the circumference of the outer conductor layer 230, whereby the area of the insulating layer 120 exposed from the opening 231 which overlaps the notch holes 241 and 241 is increased or decreased. The C-shaped bracket 240 is an example of a shielding conductor.

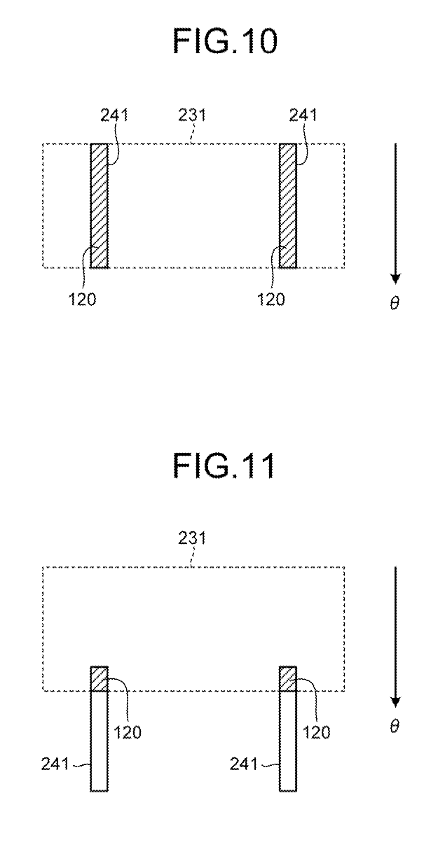

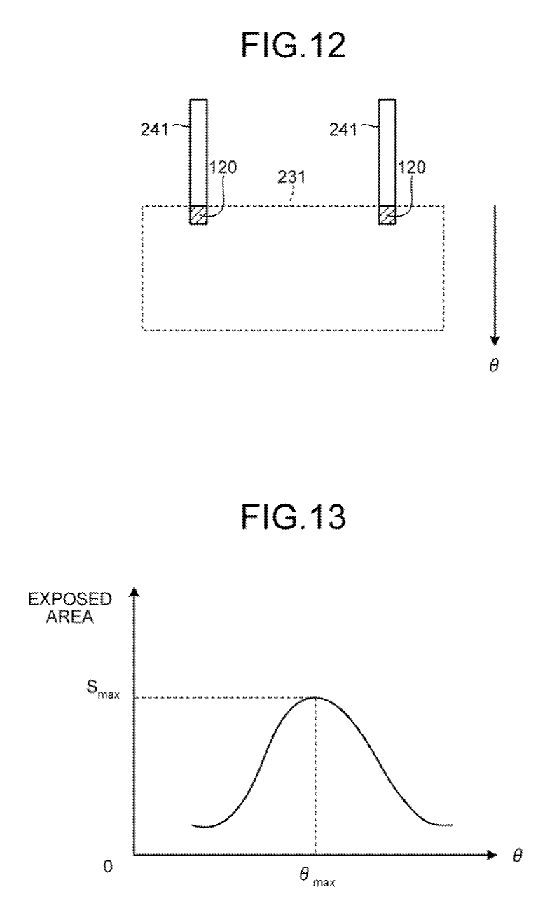

Next, an operation of shielding the opening 231 by the C-shaped bracket 240 will be described. FIG. 10 is a diagram illustrating the positional relation between the C-shaped bracket 240 and the opening 231 before a slide operation is received. FIGS. 11 and 12 are diagrams illustrating the positional relation between the C-shaped bracket 240 and the opening 231 when a slide operation is received.

As illustrated in FIG. 10, before a slide operation is received, the C-shaped bracket 240 causes the notch holes 241 and 241 to overlap the opening 231 so that the range of overlap with the opening 231 becomes its maximum while shielding a part of the opening 231 with the surface surrounding the notch holes 241 and 241. In this state, the area of the insulating layer 120 exposed from the opening 231 overlapping the notch holes 241 and 241 reaches its maximum.

When a slide operation in the positive θ direction is received, the C-shaped bracket 240 shields a part of the opening 231 with the surface surrounding the notch holes 241 and 241 while sliding in the positive θ direction on the circumference of the outer conductor layer 230 as illustrated in FIG. 11. In other words, the C-shaped bracket 240 causes the notch holes 241 and 241 to overlap the opening 231 so that the range of overlap with the opening 231 decreases while sliding in the positive θ direction on the circumference of the outer conductor layer 230. In this way, the C-shaped bracket 240 decreases the area of the insulating layer 120 exposed from the opening 231 overlapping the notch holes 241 and 241. On the other hand, when a slide operation in the negative θ direction is received, the C-shaped bracket 240 which is already shielding a part of the opening 231 as illustrated in FIG. 11 shields a part of the opening 231 with the surface surrounding the notch holes 241 and 241 while sliding in the positive θ direction on the circumference of the outer conductor layer 230. In other words, the C-shaped bracket 240 causes the notch holes 241 and 241 to overlap the opening 231 so that the range of overlap with the opening 231 increases while sliding in the negative θ direction on the circumference of the outer conductor layer 230. In this way, the C-shaped bracket 240 increases the area of the insulating layer 120 exposed from the opening 231 which overlap the notch holes 241 and 241.

When a slide operation in the negative θ direction is received, the C-shaped bracket 240 shields a part of the opening 231 with the surface surrounding the notch holes 241 and 241 while sliding in the negative θ direction on the circumference of the outer conductor layer 230 as illustrated in FIG. 12. In other words, the C-shaped bracket 240 causes the notch holes 241 and 241 to overlap the opening 231 so that the range of overlap with the opening 231 decreases while sliding in the negative θ direction on the circumference of the outer conductor layer 230. In this way, the C-shaped bracket 240 decreases the area of the insulating layer 120 exposed from the opening 231 which overlaps the notch holes 241 and 241. On the other hand, when a slide operation in the positive θ direction is received, the C-shaped bracket 240 which is already shielding a part of the opening 231 as illustrated in FIG. 12 shields a part of the opening 231 with the surface surrounding the notch holes 241 and 241 while sliding in the positive θ direction on the circumference of the outer conductor layer 230. In other words, the C-shaped bracket 240 causes the notch holes 241 and 241 to overlap the opening 231 so that the range of overlap with the opening 231 increases while sliding in the positive θ direction on the circumference of the outer conductor layer 230. In this way, the C-shaped bracket 240 increases the area of the insulating layer 120 exposed from the opening 231 which overlaps the notch holes 241 and 241. In the following description, the area of the insulating layer 120 exposed from the opening 231 which overlaps the notch holes 241 and 241 is sometimes referred simply to as an “exposed area.”

FIG. 13 is a diagram illustrating the relation between the position of the C-shaped bracket 240 and the exposed area of the insulating layer 120. The horizontal axis in FIG. 13 represents the position in the θ direction of the C-shaped bracket 240 on the circumference of the outer conductor layer 230, and the vertical axis in FIG. 13 represents the exposed area of the insulating layer 120. Moreover, it is assumed that when the C-shaped bracket 240 is at the position θₘₐₓ, the C-shaped bracket 240 causes the notch holes 241 and 241 to overlap the opening 231 so that the range of overlap with the opening 231 reaches its maximum while shielding a part of the opening 231 with the surface surrounding the notch holes 241 and 241.

As illustrated in FIG. 13, when the C-shaped bracket 240 is at the position θₘₐₓ, the exposed area of the insulating layer 120 reaches its maximum value Sₘₐₓ. It can be understood that since the range of overlap between the notch holes 241 and 241 and the opening 231 decreases as the C-shaped bracket 240 moves on the circumference of the outer conductor layer 230 from the position θₘₐₓ in the positive θ direction, the exposed area of the insulating layer 120 decreases. On the other hand, it can be understood that since the range of overlap between the notch holes 241 and 241 and the opening 231 decreases as the C-shaped bracket 240 moves on the circumference of the outer conductor layer 230 from the position θₘₐₓ in the negative θ direction, the exposed area of the insulating layer 120 increases.

As above, by shielding a part of the opening 231 of the outer conductor layer 230 with the surface surrounding the notch holes 241 and 241 of the slid C-shaped bracket 240, the exposed area of the insulating layer 120 from the opening 231 overlapping the notch holes 241 and 241 may be freely increased or decreased. Here, it can be understood that the amount of the phase lead or lag increases as the exposed area of the insulating layer 120 increases. From this, it can be understood that the phase can be finely adjusted to a target value by freely increasing or decreasing the exposed area of the insulating layer 120.

As described above, according to the second embodiment, a part of the opening 231 of the outer conductor layer 230 is shielded with the surface surrounding the notch holes 241 and 241 of the slid C-shaped bracket 240, whereby the exposed area of the insulating layer 120 exposed from the opening 231 which overlaps the notch holes 241 and 241 increases or decreases. Therefore, as compared to the related art in which a worker at the workplace peels the outer conductor layer to adjust the dimensions of the opening itself, the exposed area of the insulating layer 120 to a target value may be finely adjusted by only performing a simple operation of a slide operation of the C-shaped bracket 240 without peeling the outer conductor layer. As a result, the work load may be alleviated at the workplace and fine adjustment of phase may be made easily.

### [c] Third Embodiment

In the second embodiment, an example in which the distance between the notch holes 241 and 241 is fixed along the circumferential direction has been described. Thus, when the frequency band being used is changed, the distance between the insulating layers 120 exposed from the opening 231 overlapping the notch holes 241 and 241 may shift from ¼ of the wavelength of the changed frequency band. Therefore, in the third embodiment, a configuration in which notch holes arranged so that the mutual distance is changed along the circumferential direction are formed in a C-shaped bracket, whereby the distance between the insulating layers exposed from the opening overlapping the notch holes is increased or decreased will be described.

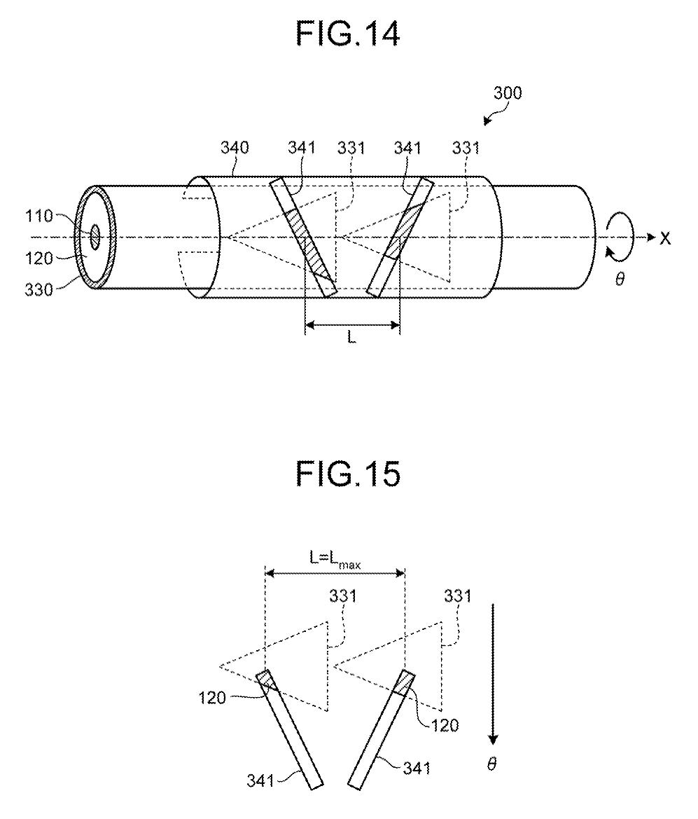

FIG. 14 is a perspective view illustrating the appearance of a coaxial cable 300 according to the third embodiment. In FIG. 14, the same portions as those of FIG. 9 will be denoted by the same reference numerals, and the description thereof will not be repeated. Moreover, the “X direction” indicated by the straight line arrow in FIG. 14 corresponds to the “axial direction” of the inner conductive wire 110. Moreover, in the following description, the term simply referred to as an “X direction” is meant to include the positive and negative directions. Moreover, the “θ direction” indicated by the arc-shaped arrow in FIG. 14 corresponds to the “circumferential direction” of the inner conductive wire 110. Moreover, in the following description, the term simply referred to as a “θ direction” is meant to include the positive and negative directions.

As illustrated in FIG. 14, the coaxial cable 300 includes the inner conductive wire 110, the insulating layer 120, an outer conductor layer 330, and a C-shaped bracket 340.

The outer conductor layer 330 is formed of a conductive material and covers the circumference of the insulating layer 120. The outer conductor layer 330 includes two openings 331 and 331 arranged along the X direction with a predetermined distance. The openings 331 and 331 are formed by peeling a part of the outer conductor layer 330 so that a part of the insulating layer 120 is exposed. Each opening 331 is formed in a triangular shape of which the width in the θ direction decreases in the negative X direction. The shape of each opening 331 is not limited to the triangular shape but may be a polygonal shape or an elliptical shape other than the triangular shape, for example. For example, each opening 331 may be formed in such a shape that the width in the θ direction changes along the X direction.

The C-shaped bracket 340 is formed in an approximately C-shape in cross-sectional view by a conductive and spring material such as a metal and is slidably attached to the circumference of the outer conductor layer 330. That is, the C-shaped bracket 340 is attached to the circumference of the outer conductor layer 330 by being externally attached to the outer conductor layer 330 using its spring properties and is slidable in the X direction and θ direction in relation to the circumference of the outer conductor layer 330.

Moreover, the C-shaped bracket 340 is disposed on the circumference of the outer conductor layer 330 so as to cover approximately the entire region of the openings 331 and 331 of the outer conductor layer 330. The C-shaped bracket 340 includes two notch holes 341 and 341 which are arranged along the X direction so as to overlap the openings 331 and 331 of the outer conductor layer 330. The notch holes 341 and 341 are arranged so that the mutual distance changes along the θ direction. Specifically, the notch holes 341 and 341 are arranged so that the mutual distance decreases as it goes toward the positive θ direction.

When a slide operation in the θ direction is received, the C-shaped bracket 340 slides along the θ direction on the circumference of the outer conductor layer 330. Moreover, the C-shaped bracket 340 shields a part of the openings 331 and 331 with the surface surrounding the notch holes 341 and 341 while sliding along the θ direction on the circumference of the outer conductor layer 330, whereby the distance L between the insulating layers 120 exposed from the openings 331 and 331 which overlap the notch holes 341 and 341 is increased or decreased.

Moreover, when a slide operation in the X direction is received, the C-shaped bracket 340 slides along the X direction on the circumference of the outer conductor layer 330. Furthermore, the C-shaped bracket 340 shields the openings 331 and 331 with the surface surrounding the notch holes 341 and 341 while sliding along the X direction on the circumference of the outer conductor layer 330, whereby the area of the insulating layer 120 exposed from the openings 331 and 331 which overlap the notch holes 341 and 341 is increased or decreased. The C-shaped bracket 340 is an example of a shielding conductor.

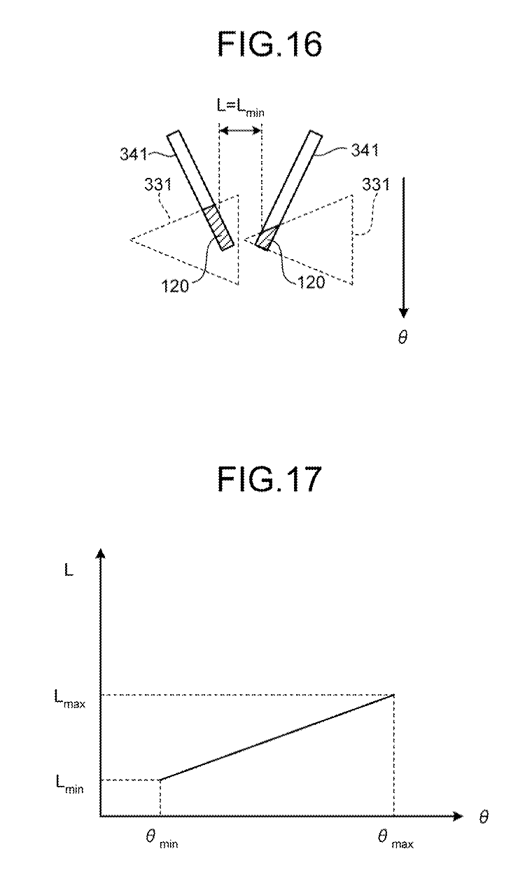

Next, an operation of shielding the openings 331 and 331 by the C-shaped bracket 340 having received a slide operation in the θ direction will be described. FIG. 15 is a diagram illustrating the positional relation between the C-shaped bracket 340 and the openings 331 and 331 before a slide operation in the θ direction is received. FIG. 16 is a diagram illustrating the positional relation between the C-shaped bracket 340 and the openings 331 and 331 when a slide operation in the θ direction is received.

As illustrated in FIG. 15, the C-shaped bracket 340 before receiving the slide operation in the θ direction causes the notch holes 341 and 341 to overlap the openings 331 and 331 so that the distance between the ranges of overlap with the openings 331 and 331 reaches its maximum while shielding a part of the openings 331 and 331 with the surface surrounding the notch holes 341 and 341. In this state, the distance L between the insulating layers 120 exposed from the openings 331 and 331 which overlap the notch holes 341 and 341 becomes the maximum value Lₘₐₓ.

When a slide operation in the negative θ direction is received, the C-shaped bracket 340 shields a part of the openings 331 and 331 with the surface surrounding the notch holes 341 and 341 while sliding in the negative θ direction on the circumference of the outer conductor layer 330 as illustrated in FIG. 16. In other words, the C-shaped bracket 340 causes the notch holes 341 and 341 to overlap the openings 331 and 331 so that the distance between the ranges of overlap with the openings 331 and 331 decreases while sliding in the positive θ direction on the circumference of the outer conductor layer 330. In this way, the C-shaped bracket 340 decreases the distance L between the insulating layers 120 exposed from the openings 331 and 331 which overlap the notch holes 341 and 341 from the maximum value Lₘₐₓ to the minimum value Lₘᵢₙ.

On the other hand, when a slide operation in the positive θ direction is received, the C-shaped bracket 340 which is already shielding a part of the openings 331 and 331 as illustrated in FIG. 16 shields a part of the openings 331 and 331 with the surface surrounding the notch holes 341 and 341 while sliding in the positive θ direction on the circumference of the outer conductor layer 330. In other words, the C-shaped bracket 340 causes the notch holes 341 and 341 to overlap the openings 331 and 331 so that the distance between the ranges of overlap with the openings 331 and 331 increases while sliding in the positive θ direction on the circumference of the outer conductor layer 330. In this way, the C-shaped bracket 340 increases the distance L between the insulating layers 120 exposed from the openings 331 and 331 which overlap the notch holes 341 and 341 from the minimum value Lₘᵢₙ to the maximum value Lₘₐₓ. In the following description, the distance between the insulating layers 120 exposed from the openings 331 and 331 which overlap the notch holes 341 and 341 is sometimes referred simply to as an “exposure distance.”

FIG. 17 is a diagram illustrating the relation between the position of the C-shaped bracket 340 and the exposure distance of the insulating layer 120. The horizontal axis in FIG. 17 represents the position in the θ direction of the C-shaped bracket 340 on the circumference of the outer conductor layer 330, and the vertical axis in FIG. 17 represents the exposure distance of the insulating layer 120. Moreover, it is assumed that when the C-shaped bracket 340 is at the position θₘₐₓ, the C-shaped bracket 340 causes the notch holes 341 and 341 to overlap the openings 331 and 331 so that the distance between the ranges of overlap with the openings 331 and 331 reaches its maximum while shielding a part of the openings 331 and 331 with the surface surrounding the notch holes 341 and 341. Moreover, it is assumed that when the C-shaped bracket 340 is at the position θₘᵢₙ, the C-shaped bracket 340 causes the notch holes 341 and 341 to overlap the openings 331 and 331 so that the distance between the ranges of overlap with the openings 331 and 331 reaches its minimum while shielding a part of the openings 331 and 331 with the surface surrounding the notch holes 341 and 341.

As illustrated in FIG. 17, when the C-shaped bracket 340 is at the position θₘₐₓ, the exposure distance of the insulating layer 120 becomes the maximum value Lₘₐₓ. Moreover, it can be understood that since the distance between the ranges of the openings 331 and 331 which overlap with the notch holes 341 and 341 decreases as the C-shaped bracket 340 moves along the negative θ direction on the circumference of the outer conductor layer 330 from the position θₘₐₓ, the exposure distance of the insulating layer 120 decreases. On the other hand, when the C-shaped bracket 340 is at the position θₘᵢₙ, the exposure distance of the insulating layer 120 becomes the minimum value Lₘᵢₙ. Moreover, it can be understood that since the distance between the ranges of the openings 331 and 331 which overlap with the notch holes 341 and 341 increases as the C-shaped bracket 340 moves along the positive θ direction on the circumference of the outer conductor layer 330 from the position θₘᵢₙ, the exposure distance of the insulating layer 120 increases.

As above, by shielding a part of the openings 331 and 331 of the outer conductor layer 330 with the surface surrounding the notch holes 341 and 341 of the C-shaped bracket 340 which is slid in the θ direction, it is possible to freely increase or decrease the exposure distance of the insulating layer 120 from the openings 331 and 331 which overlap the notch holes 341 and 341. In this way, even when the frequency band being used is changed, the exposure distance of the insulating layer 120 can be readjusted to be ¼ of the wavelength of the changed frequency band.

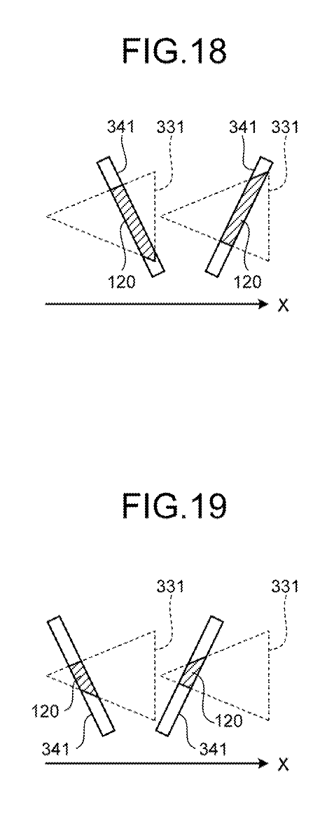

Next, an operation of shielding the openings 331 and 331 by the C-shaped bracket 340 having received a slide operation in the X direction will be described. FIG. 18 is a diagram illustrating the positional relation between the C-shaped bracket 340 and the openings 331 and 331 before a slide operation in the X direction is received. FIG. 19 is a diagram illustrating the positional relation between the C-shaped bracket 340 and the openings 331 and 331 when a slide operation in the X direction is received.

As illustrated in FIG. 18, before a slide operation is received, the C-shaped bracket 340 causes the notch holes 341 and 341 to overlap the openings 331 and 331 so that the range of overlap with the openings 331 and 331 reaches its maximum while shielding a part of the openings 331 and 331 with the surface surrounding the notch holes 341 and 341. In this state, the area of the insulating layer 120 exposed from the openings 331 and 331 which overlap the notch holes 341 and 341 reaches its maximum.

When a slide operation in the negative X direction is received, the C-shaped bracket 340 shields the openings 331 and 331 with the surface surrounding the notch holes 341 and 341 while sliding in the negative X direction on the circumference of the outer conductor layer 330 as illustrated in FIG. 19. In other words, the C-shaped bracket 340 causes the notch holes 341 and 341 to overlap the openings 331 and 331 so that the range of overlap with the openings 331 and 331 decreases while sliding in the negative X direction on the circumference of the outer conductor layer 330. In this way, the C-shaped bracket 340 decreases the area of the insulating layer 120 exposed from the openings 331 and 331 which overlap the notch holes 341 and 341.

On the other hand, when a slide operation in the positive X direction is received, the C-shaped bracket 340 which is already shielding a part of the openings 331 and 331 as illustrated in FIG. 19 shields a part of the openings 331 and 331 with the surface surrounding the notch holes 341 and 341 while sliding in the positive X direction on the circumference of the outer conductor layer 330. In other words, the C-shaped bracket 340 causes the notch holes 341 and 341 to overlap the openings 331 and 331 so that the range of overlap with the openings 331 and 331 increases while sliding in the positive X direction on the circumference of the outer conductor layer 330. In this way, the C-shaped bracket 340 increases the area of the insulating layer 120 exposed from the openings 331 and 331 which overlap the notch holes 341 and 341. In the following description, the area of the insulating layer 120 exposed from the openings 331 and 331 which overlap the notch holes 341 and 341 is sometimes referred simply to as an “exposed area.”

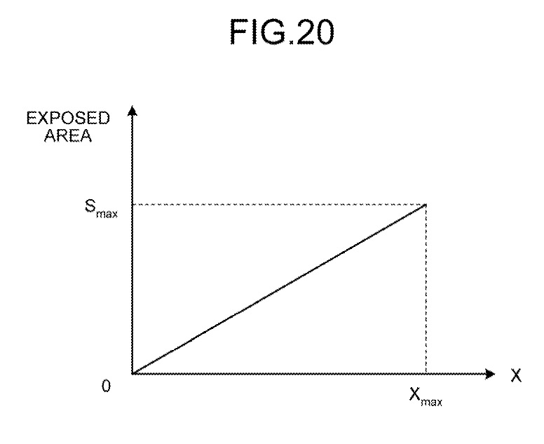

FIG. 20 is a diagram illustrating the relation between the position of the C-shaped bracket 340 and the exposed area of the insulating layer 120. The horizontal axis in FIG. 20 represents the position in the θ direction of the C-shaped bracket 340 on the circumference of the outer conductor layer 330, and the vertical axis in FIG. 20 represents the exposed area of the insulating layer 120. Moreover, it is assumed that when the C-shaped bracket 340 is at the position Xₘₐₓ, the C-shaped bracket 340 causes the notch holes 341 and 341 to overlap the openings 331 and 331 so that the range of overlap with the openings 331 and 331 reaches its maximum while shielding a part of the openings 331 and 331 with the surface surrounding the notch holes 341 and 341.

As illustrated in FIG. 20, when the C-shaped bracket 340 is at the position Xₘₐₓ, the exposed area of the insulating layer 120 reaches its maximum value Sₘₐₓ. It can be understood that since the range of overlap between the notch holes 341 and 341 and the openings 331 and 331 decreases as the C-shaped bracket 340 moves on the circumference of the outer conductor layer 330 from the position Xₘₐₓ in the negative X direction, the exposed area of the insulating layer 120 decreases.

As above, by shielding a part of the openings 331 and 331 of the outer conductor layer 330 with the surface surrounding the notch holes 341 and 341 of the slid C-shaped bracket 340, the exposed area of the insulating layer 120 from the openings 331 and 331 overlapping the notch holes 341 and 341 may be freely increased or decreased. Here, it can be understood that the amount of the phase lead or lag increases as the exposed area of the insulating layer 120 increases. From this, it can be understood that the phase can be finely adjusted to a target value by freely increasing or decreasing the exposed area of the insulating layer 120.

As described above, according to the third embodiment, the notch holes 341 and 341 are formed in the C-shaped bracket 340 so that the mutual distance changes along the θ direction. Moreover, by shielding a part of the openings 331 and 331 of the outer conductor layer 330 with the surface surrounding the notch holes 341 and 341 of the C-shaped bracket 340 slid along the θ direction, the exposure distance of the insulating layer 120 exposed from the openings 331 and 331 which overlap the notch holes 341 and 341 increases or decreases. Therefore, when the frequency band being used is changed, the exposure distance of the insulating layer 120 can be readjusted to be ¼ of the wavelength of the changed frequency band. As a result, even when the frequency band being used is changed, the reflection waves occurring in the openings 331 and 331 and to suppress impedance mismatch may be cancelled.

Moreover, according to the third embodiment, the openings 331 and 331 having a shape such that the width along the θ direction changes along the X direction are formed in the outer conductor layer 330. Moreover, by shielding a part of the openings 331 and 331 of the outer conductor layer 330 with the surface surrounding the notch holes 341 and 341 of the C-shaped bracket 340 which is slid in the X direction, the exposed area of the insulating layer 120 from the openings 331 and 331 which overlap the notch holes 341 and 341 increases or decreases. Therefore, as compared to the related art in which a worker at the workplace peels the outer conductor layer to adjust the dimensions of the opening itself, fine adjustment of the exposed area of the insulating layer 120 to a target value can be made by only performing a simple operation of a slide operation of the C-shaped bracket 340 without peeling the outer conductor layer. As a result, the work load may be alleviated at the workplace and fine adjustment of phase may be made easily.

In the third embodiment, although a configuration in which two openings 331 and 331 are formed in the outer conductor layer 330, and two notch holes 341 and 341 are formed in the C-shaped bracket 340 has been described, the number of openings and notch holes may be two or more.

Moreover, in the third embodiment, although an example in which the exposure distance of the insulating layer 120 is adjusted to be ¼ of the wavelength of the frequency band being used by the operation of sliding the C-shaped bracket 340 in the θ direction has been described, a scale indicating the slide position in the θ direction of the C-shaped bracket 340 corresponding to the frequency band may be formed on the outer conductor layer 330.

According to an aspect of the coaxial cable disclosed in this application, the work load at the workplace may be alleviated and fine adjustment of phase may be facilitated.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A coaxial cable comprising:
an inner conductive wire;
an insulating layer configured to cover an outer circumference of the inner conductive wire;
an outer conductor layer configured to cover an outer circumference of the insulating layer and include an opening that exposes a part of the insulating layer; and
a shielding conductor configured to be slidably attached to the outer circumference of the outer conductor layer so as to shield at least a part of the opening while sliding on the outer circumference of the outer conductor layer, thereby increasing or decreasing an area of the insulating layer exposed from the opening.

2. The coaxial cable according to claim 1,
wherein the shielding conductor shields at least a part of the opening while sliding on the outer circumference of the outer conductor layer along a circumferential direction of the inner conductive wire so as to increase or decrease the area of the insulating layer exposed from the opening.

3. The coaxial cable according to claim 1,
wherein the shielding conductor includes a notch hole configured to overlap the opening and shields a part of the opening with a surface surrounding the notch hole while sliding on the outer circumference of the outer conductor layer so as to increase or decrease the area of the insulating layer exposed from the opening which overlaps the notch hole.

4. The coaxial cable according to claim 3,
wherein the outer conductor layer includes a plurality of openings arranged along an axial direction of the inner conductive wire,
wherein the shielding conductor includes a plurality of notch holes which are arranged so that a mutual distance changes along the circumferential direction of the inner conductive wire, and which overlaps the plurality of openings, and
wherein the shielding conductor shields the plurality of openings with the surface surrounding the plurality of notch holes while sliding on the outer circumference of the outer conductor layer along the circumferential direction of the inner conductive wire so as to increase or decrease the distance between the insulating layers exposed from the plurality of openings which overlaps the plurality of notch holes.

5. The coaxial cable according to claim 4,
wherein each of the openings is formed in a shape such that a width of each opening along the circumferential direction of the inner conductive wire changes along the axial direction of the inner conductive wire, and
wherein the shielding conductor shields the plurality of openings with the surface surrounding the plurality of notch holes while sliding on the outer circumference of the outer conductor layer along the axial direction of the inner conductive wire so as to increase or decrease the area of the insulating layer exposed from the plurality of openings which overlap the plurality of notch holes.
